(19) United States
(12) Patent Application Publication
(10) Pub. No.: US 2026/0081990 A1
(43) Pub. Date: Mar. 19, 2026

(54) ENHANCED DEVICE SECURITY IN USER SLEEP MODE WITH CONTEXT OF A WEARABLE DEVICE

(71) Applicant: MOTOROLA MOBILITY LLC, WILMINGTON, DE (US)

(72) Inventors: Ranjeet Gupta, Aurora, IL (US); Daniel C Chisu, Franklin Park, IL (US)

(21) Appl. No.: 18/885,064

(22) Filed: Sep. 13, 2024

(51) Int. Cl. H04M 1/72463; G06F 21/32; H04M 1/72454

(52) U.S. Cl. CPC H04M 1/724631; G06F 21/32; H04M 1/72454

(57) ABSTRACT

A method provides techniques for receiving, by at least one processor of an electronic device that includes a communications subsystem, a sleep status indication of a user of the electronic device. A sleep status change is detected based on the received sleep status indication. In response to the sleep status change indicating the device user is asleep, features for unlocking the electronic device based on input from at least one biometric security-access system of the electronic device are disabled.

### BACKGROUND

### 1. Technical Field

The present disclosure generally relates to electronic devices, and more specifically to security of electronic devices.

### 2. Description of the Related Art

Maintaining security of electronic devices such as smartphones and tablets from unauthorized access/unlocking is important for several key reasons. These devices often store a wealth of sensitive information, ranging from personal data to work-related materials, making them valuable targets for attackers. For example, smartphones and tablets store sensitive personal information such as contacts, photos, messages, emails, and passwords. If unauthorized users gain access, they can view, steal, and/or misuse this data. Additionally, many users have mobile payment apps such as Google Pay, Apple Pay, or banking apps installed on their smartphones. An unauthorized user could make transactions or access financial information if they unlock the device. Furthermore, many people keep their social media accounts logged in on their devices. Unauthorized users can take control of these accounts to post harmful content, spy on private messages, or impersonate the owner. Thus, unauthorized device access poses a security threat to users of electronic devices.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement enhanced device security in user sleep mode, according to one or more embodiments;

FIG. 2 illustrates an example of a third party being prevented from biometrically unlocking an electronic device while the associated user is asleep, according to one or more embodiments;

FIG. 3 is an exemplary biometric authentication attempt warning message, according to one or more embodiments;

FIG. 4 shows an exemplary configuration user interface, according to one or more embodiments;

FIG. 5 depicts a flowchart of a computer-implemented method for enhanced device security in user sleep mode, according to one or more embodiments; and

FIG. 6 depicts a flowchart of a computer-implemented method for issuing alerts and alarms in response to a biometric authentication attempt while the associated user is asleep, according to one or more embodiments.

### DETAILED DESCRIPTION

According to aspects of the present disclosure, an electronic device, a method, and a computer program product provide techniques for enhanced device security while in user sleep mode, with context of a wearable device. A wearable device such as a smartwatch can detect a sleeping condition of a user. The wearable device can communicate the sleeping condition of the user to an electronic device, such as a smartphone or tablet computer. In response to detecting that the user is sleeping, the electronic device can disable/prevent unlocking of the device based on biometric security-access systems (e.g., fingerprint scanners, facial identification, iris identification).

Using biometric authentication (such as fingerprints) to unlock a smartphone while the person is asleep poses several risks and disadvantages, especially when exploited by malicious actors. While biometric systems are generally considered secure and convenient, they are not immune to misuse, particularly in situations where the user is asleep. One significant issue is that biometric authentication does not require active consent from the user. As an example, a malicious actor can easily press the finger of a sleeping person against the phone sensor to unlock the person's phone without the person's knowledge. The unauthorized unlocking of an electronic device can lead to a serious invasion of privacy, as the victim may not even realize his/her phone was accessed, and personal data, photos, messages, or other sensitive information could be viewed, copied, or manipulated. The potential for unauthorized biometric unlocking of a device while a user is asleep highlights the need for additional safeguards. The disclosed embodiments address the aforementioned problems by detecting a sleeping condition of a user and autonomously disabling unlocking of the electronic device by the use of biometric security-access systems. In this way, unlocking the person's device by performing biometric authentication of the person while the person is in a sleeping state is prevented, thereby enhancing device security.

One or more embodiments can include: an electronic device including a communications subsystem enabling the electronic device to communicatively connect to a second electronic device; a memory having stored thereon a user sleep mode security (USMS) module; at least one processor coupled to the communications subsystem and the memory and which processes program code of the USMS module, the at least one processor configured to cause the electronic device to: receive a sleep status indication of a user of the electronic device via the communications subsystem; detect a sleep status change based on the received sleep status indication; and in response to the sleep status change indicating the device user is asleep, disable features for unlocking the electronic device based on input from at least one biometric security-access system of the electronic device.

Embodiments can provide a method that includes: receiving, by at least one processor of an electronic device that includes a communications subsystem, a sleep status indication of a user of the electronic device via the communications subsystem; detecting a sleep status change based on the received sleep status indication; and in response to the sleep status change indicating the device user is asleep, disabling features for unlocking the electronic device based on input from at least one biometric security-access system of the electronic device.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

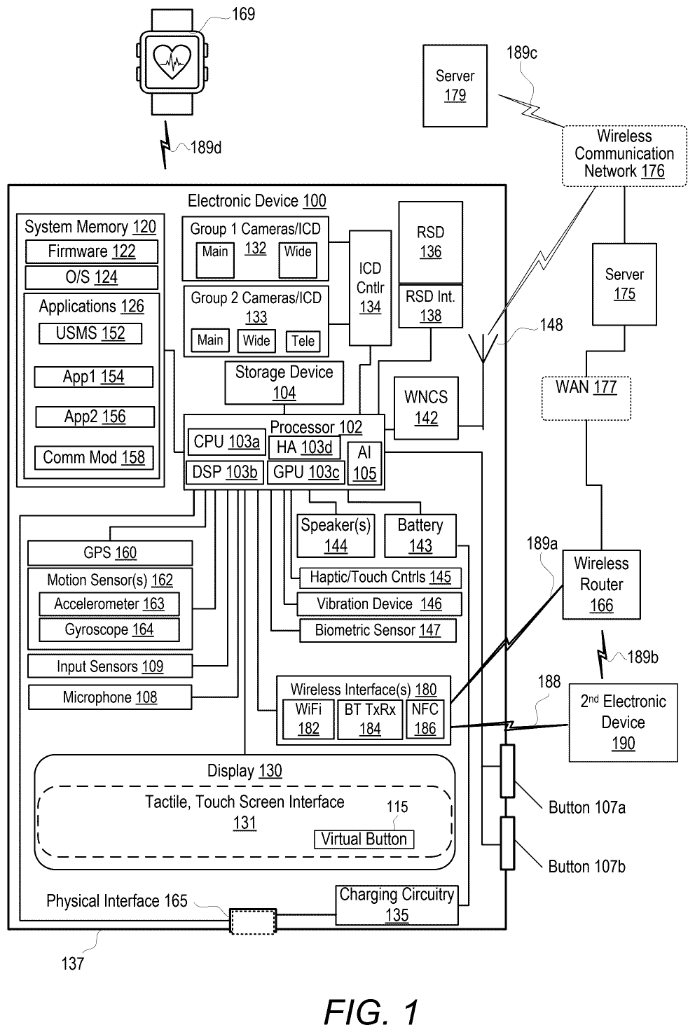

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that configure the device for enhanced device security in user sleep mode, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

For simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, user sleep mode security (USMS) module 152, other applications, indicated as App1 154 and App2 156, and communication module 158. Each module and/or application provides program instructions/code that are processed by processor 102 to configures/cause processor 102 and/or other components of electronic device 100 to perform specific operations, as described herein. Descriptive names assigned to these modules add no functionality and are provided solely to identify the underlying features performed by processing the different modules. For example, user sleep mode security (USMS) module 152 can include program instructions for implementing features of the disclosed embodiments. The USMS module 152 can include instructions that cause or configure processor 102 to receive a sleep status indication, indicating that a user is asleep or awake. Upon detecting a sleep status change, one or more actions are taken on the electronic device regarding one or more biometric-security access systems. The sleep status change can reflect a transition from an awake state of a user to a sleeping state of the user. The sleep status change can reflect a transition from a sleeping state of a user to an awake state of the user. Upon detecting a transition from an awake state to a sleeping state, some embodiments include disabling the unlocking of the electronic device 100 based on detected completion of a successful biometric authentication. Conversely, in response to detecting a transition from a sleeping state to an awake state, some embodiments include enabling the unlocking of the electronic device 100 in response to detecting completion of a successful biometric authentication. Other features are described in further detail throughout this disclosure.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133. In one or more embodiments, ICDs can be utilized to enable biometric authentication using facial image or iris scan recognition.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger or stylus on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide for multiple integrated displays within electronic device 100 and references to integrated display 130 are assumed to refer to one or all of these multiple integrated displays.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera), which provides facial recognition for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless network communication subsystem (WNCS) 142, which can represent one or more front end devices (not shown) that are each coupled to one or more antennas 148. In one or more embodiments, WNCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, such as second electronic device 190 via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, such as second electronic device 190, which can be similarly connected to wireless communication network 176. Second electronic device 190 can be a communication device, such as a smartphone.

In one or more embodiments, electronic device 100 can communicate wirelessly with external wireless devices, such as a WiFi router 166 or second electronic device 190, via one or more of short-range wireless interface(s) 180. In one or more embodiments, WiFi router 166 may be connected to a WAN 177 and/or server 175. Server 175 may also be connected to wireless communication network 176, which may enable connection to other servers, such as server 179 via communication signal 189c. Electronic device 100 can wirelessly communicate with second electronic device 190 via communication signal 188 (communicating between wireless interface(s) 180 and second electronic device 190). Communication signal 189a and communication signal 189b provide a communication path from electronic device 100 to second electronic device 190. In one or more embodiments, signals 188 and/or signals 189a may be transmitted by short range communication device(s) within wireless interface(s) 180. In one or more embodiments, a wearable computing device 169, such as a smartwatch, fitness tracker, or the like, may be paired with electronic device 100, and provide biometric data such as sleep status indications to the electronic device 100. In one or more embodiments, the sleep status indications can be sent periodically from the wearable computing device 169 and/or second electronic device 190 to the electronic device 100. Communication signal 189d may be used to enable communication between electronic device 100 and wearable computing device 169. Wireless interface(s) 180 can include short-range wireless communication adapters/transceivers, such as wireless fidelity (Wi-Fi) transceiver 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, WNCS 142 with antenna(s) 148 and wireless interface(s) 180 collectively provide/represent the wireless communications subsystem of electronic device 100. Electronic device 100 of FIG. 1 is only a specific example of a device that can be used to implement the embodiments of the present disclosure.

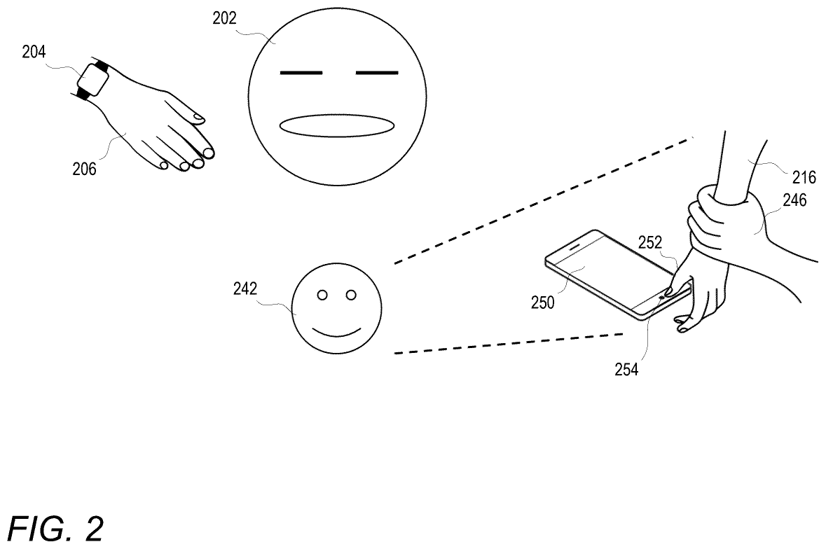

FIG. 2 illustrates an example of a third party being prevented from biometrically unlocking an electronic device while the associated user is asleep, according to one or more embodiments. A first user 202 is in a sleeping state (i.e., detected as being asleep/sleeping). The user 202 is wearing a wearable computing device 204 on her hand 206. In one or more embodiments, the wearable computing device 204 comprises a smartwatch, fitness tracker, and/or other suitable wearable computing device. Modern wearable computing devices, such as smartwatches and fitness trackers, can use a combination of sensors and algorithms to determine if a person is asleep or awake. As an example, the wearable computing devices can include accelerometers and/or other motion sensors, and motion can be used as a criterion for determining a sleep status. These motion sensors track movement of the user that is wearing the computing device. If the user has not moved by more than a preset amount expected when awake (as determined by scientific or empirical study) for a predetermined duration (e.g., 5 minutes), a sleeping state can be inferred. Conversely, frequent movement can indicate that a user is awake. Additionally, in other embodiments, detected heart rate can be used as a criterion for determining a person's sleep status. A person's heart rate tends to be lower and more stable during sleep. Accordingly, by monitoring changes in heart rate, the wearable computing device can infer the sleep status of a user. Some sensor devices can also monitor other indicators such as respiratory rate, blood oxygen levels, and detection of snoring. Embodiments may combine multiple criteria and detected/sensed conditions to provide a more comprehensive assessment of the sleep state of a user.

A second person 242 having hand 246 may observe the user 202 in a sleeping state, and attempt to unlock electronic device 250, which is associated with user 202, by using his hand 246 to manipulate the arm 216 of user 202. In the presented example, second person 242 manipulates the arm 216 of user 202 such that the thumb 252 of user 202 is presented to fingerprint scanner 254, in an attempt to unlock electronic device 250. Disclosed embodiments provide features to thwart the attempt of second person 242 to unlock the electronic device 250 using biometric information belonging to user 202. Upon receiving, from wearable computing device 204, an indication that the user 202 is asleep, the electronic device 250 disables unlocking of the electronic device 250 based on biometric security-access system activity. In this way, disclosed embodiments can prevent unauthorized access of electronic devices using biometric identification of a user that is asleep, thereby improving overall device security. Additionally, in one embodiment, the detected unauthorized attempt can trigger an alert (which can be silent) to inform the asleep user that the person is attempting to access her device.

While the example depicted in FIG. 2 shows attempted biometric unlocking of a device using a fingerprint, one or more embodiments may disable all available biometric security-access systems upon detecting a sleeping state of the user. These biometric security-access systems can include, but are not limited to, a fingerprint scanner, a face identification system, an iris identification system, a voice identification system, and/or other type of biometric security-access system. Iris identification is a biometric identification technique that uses the unique patterns in the iris of the eye to verify a person's identity. Similarly, facial identification is a biometric identification technique that uses the unique patterns within the face of a person to verify the person's identity. Voice identification can utilize unique vocal characteristics of a person to identify the person's identity. In the specific example of the voice identification system being locked, the person cannot play an audio or video clip of the user's voice to unlock the user's device while the user is determined to be asleep. Other types of biometric identification may be used in disclosed embodiments.

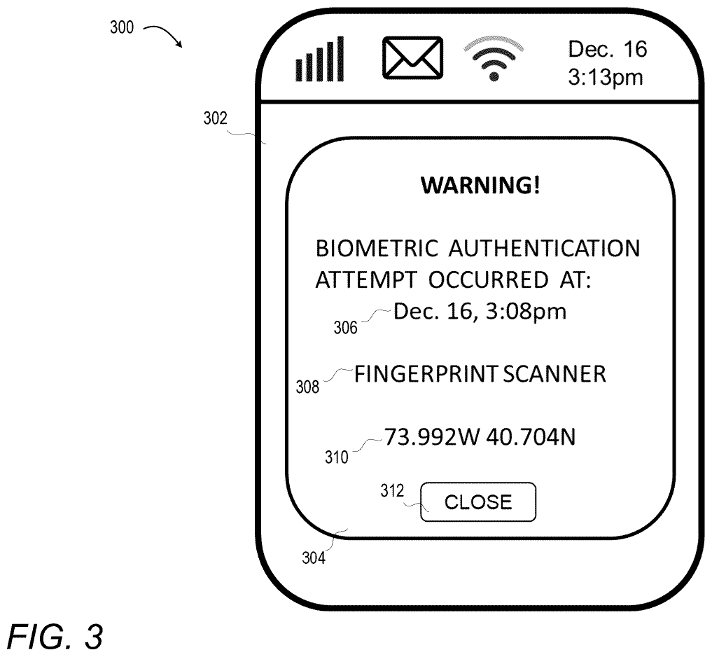

FIG. 3 is an exemplary biometric authentication attempt warning message, according to one or more embodiments. Device 300 may be similar to electronic device 100 depicted in FIG. 1. Device 300 includes display 302. Biometric authentication attempt warning message 304 is rendered and presented on display 302. The biometric authentication attempt warning message can be generated and presented on an electronic device in response to detecting an attempted device unlocking via a biometric security-access system while the associated user is determined to be in a sleep state. In one or more embodiments, the biometric authentication attempt warning message can include one or more metadata items pertaining to the attempted device unlocking. The metadata can include, but is not limited to, a date and/or time that the unauthorized device unlock attempt occurred, shown at 306, a biometric security-access system used for the device unlock attempt, shown at 308, a geographical position 310, and/or other associated metadata. In one or more embodiments, the geographical position 310 can be obtained from an onboard geolocation system, such as shown at 160 in FIG. 1. In one or more embodiments, the geographical position 310 can be rendered and presented as longitude and latitude values, such as shown in FIG. 3. In some embodiments, the geographical position 310 may be rendered and presented in another manner, such as a street address, map view, or the like. The biometric authentication attempt warning message can serve to alert the user of device 300 that such access was attempted while the user of the device 300 was asleep. The biometric authentication attempt warning message 304 may further include a close button 312, which when invoked, causes the biometric authentication attempt warning message 304 to be cleared (removed from the display 302).

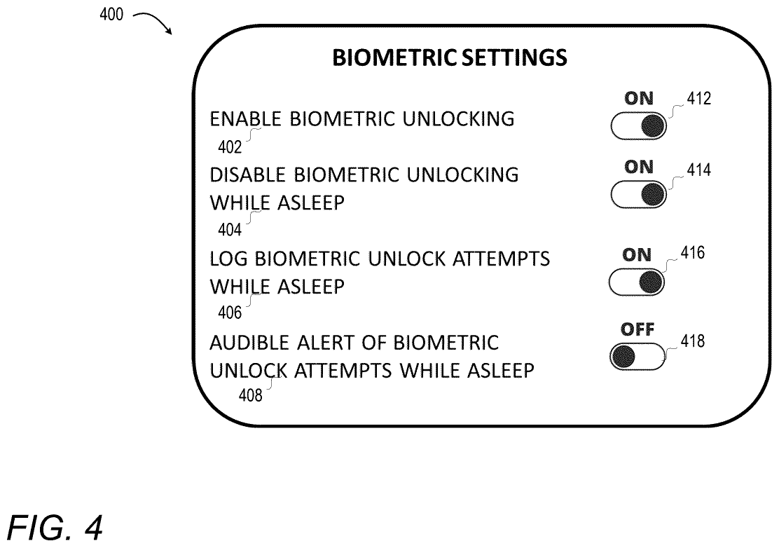

FIG. 4 shows an exemplary configuration user interface, according to one or more embodiments. User interface 400 may be rendered on an electronic display of an electronic device, such as device 100 shown in FIG. 1. User interface 400 includes an option 402 to enable biometric unlocking. Option 402 is currently enabled, as indicated by user interface element 412. When option 402 is enabled, the electronic device may be unlocked via one or more biometric security-access systems. User interface 400 includes an option 404 to disable biometric unlocking while a user is determined to be asleep. Option 404 is currently enabled, as indicated by user interface element 414. When option 404 is enabled, the electronic device is prevented from being unlocked via one or more biometric security-access systems if the user is determined to be asleep. User interface 400 includes an option 406 to log biometric unlocking attempts while a user is determined to be asleep. Option 406 is currently enabled, as indicated by user interface element 416. When option 406 is enabled, an attempt to biometrically unlock the electronic device while the user is asleep causes a message to be logged and/or rendered and presented, such as shown in FIG. 3. User interface 400 includes an option 408 to produce an audible alert in response to biometric unlocking attempts while a user is determined to be asleep. Option 408 is currently disabled, as indicated by user interface element 418. The options shown in FIG. 4 are not exhaustive, and other options may be included in addition to, or instead of, those shown in FIG. 4, in one or more embodiments

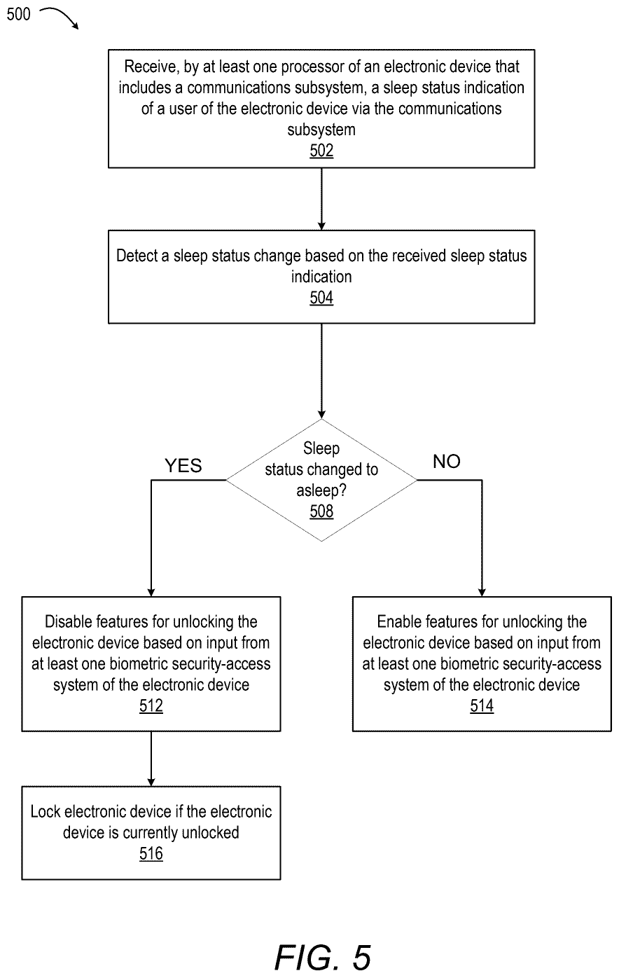

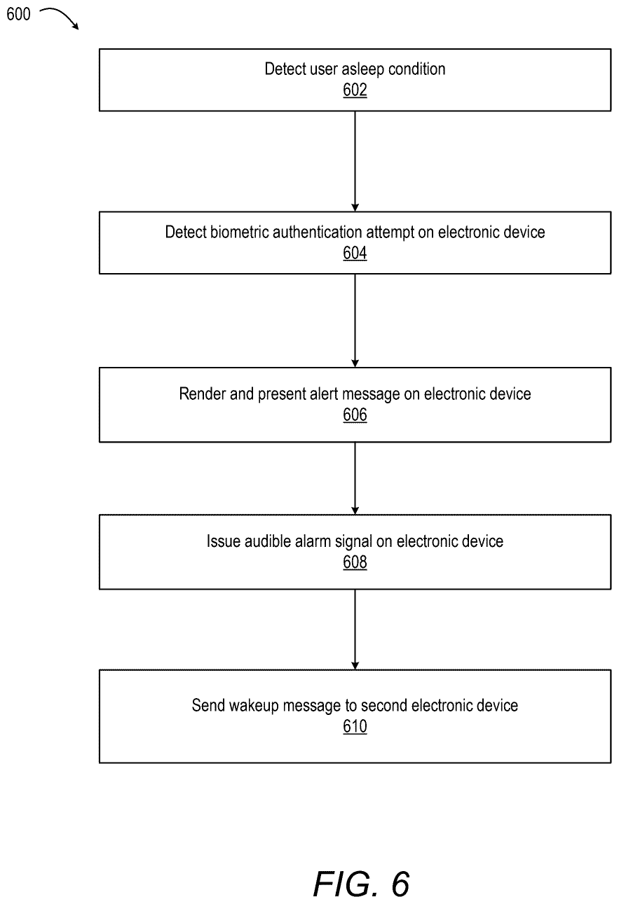

Referring now to the flowcharts presented by FIG. 5-FIG. 6, the descriptions of the methods in FIG. 5-FIG. 6 are provided with general reference to the specific components and features illustrated within the preceding FIG. 1-4. Specific components referenced in the methods of FIG. 5-FIG. 6 may be identical or similar to components of the same name used in describing preceding FIGS. 1-4. In one or more embodiments, processor 102 (FIG. 1) configures electronic device 100 (FIG. 1) to provide the described functionality of the methods of FIG. 5-FIG. 6 by executing program code for one or more modules or applications provided within system memory 120 of electronic device 100, including user sleep mode security (USMS) module 152.

FIG. 5 depicts a flowchart of a computer-implemented method for enhanced device security while the device is in user sleep mode, according to one or more embodiments. The method 500 starts at block 502, where a sleep status indication is received by the electronic device. In one or more embodiments, the sleep status indication is sent from a second electronic device. The second electronic device can be a wearable computing device, such as a smartphone, fitness tracker, pedometer, or the like. In one or more embodiments, the second electronic device can include a camera. In one or more embodiments, the second electronic device makes a determination of a sleep status based on optical, auditory, and/or biometric parameters. As examples, the second electronic device can utilize image processing and/or object recognition to identify a person and determine a sleep state for that person, such as by detecting closed eyes, lack of motion, and/or other parameters. Additionally, the second electronic device can utilize motion analysis along with biometric information such as heart rate and/or respiratory rate to determine a sleep state for a person. In embodiments, the sleep status can be received via Bluetooth, WiFi, Infrared, Zigbee, NFC (Near Field Communication) UWB (Ultra-Wideband), LTE/NR sidelink, and/or other suitable communication technique. In some embodiments, the electronic device can detect a sleeping state of a user directly, without the use of a second electronic device, and in response to detecting a sleeping state, disable device unlocking via biometric authentication. In one or more embodiments, the communications subsystem comprises a Wireless Fidelity (WiFi) module that connects the electronic device to a WiFi network on which the second electronic device is connected and a Bluetooth adapter that provides Bluetooth connectivity with the second electronic device, where the electronic device receives the sleep status indication via one of WiFi and Bluetooth.

The method 500 continues to block 504, where a sleep status change is detected based on the received sleep status indication. In one or more embodiments, the sleep status indication is received via a protocol from the group consisting of WiFi and Bluetooth. In one or more embodiments, a periodic sleep status message may be received by the electronic device. In one or more embodiments, a periodic sleep status message is received by the electronic device every 20 seconds. A shorter or longer period may be used in some embodiments. The sleep status message may include a binary data field indicating asleep or awake for a user. The method 500 continues to decision block 508, where a check is made to determine if the sleep status of the user has changed from the user being awake to the user being asleep. If, at block 508, it is determined that the sleep status of the user has changed from awake to asleep, the method 500 then proceeds to block 512, where features for unlocking the electronic device based on input from at least one biometric security-access system of the electronic device are disabled. The biometric security-access systems can include fingerprint sensors, face recognition systems, iris identification systems, and so on. In one or more embodiments, the biometric interfaces that are disabled include a fingerprint scanner, face identification system, and/or iris identification system. In one or more embodiments, when a user sleep state of ‘asleep’ is detected, the biometric interfaces may remain enabled, but logic may be implemented by the at least one processor to prevent unlocking of the electronic device while a user is determined to be asleep, even if a successful biometric authentication is detected. In this way, disclosed embodiments can log device unlock attempts based on biometric input that occurred while the user is deemed to be asleep. These unauthorized device unlock attempts can be later provided to the user, such as via a biometric authentication attempt warning message, such as depicted in FIG. 3. In this way, disclosed embodiments alert a user that an unsuccessful device unlock attempt based on biometric input was made while the user was asleep. By notifying the user of the unsuccessful device unlock attempt based on biometric input, the user then has an opportunity to take a mitigation action, such as putting his/her device in a safe location before going to sleep and/or admonishing the person who attempted to unlock the user's device.

Optionally, in one or more embodiments, the method 500 may continue to block 516, where an unlocked electronic device is automatically locked upon detecting a transition to a sleep state. In an example usage scenario, a user may fall asleep while watching a movie on his/her electronic device. The electronic device may typically remain unlocked while media is playing. In a case where a user falls asleep 10 minutes into a movie having a length of 2 hours and 30 minutes, that leaves a vulnerable period of over two hours where the device is unlocked and the user is asleep. In such a scenario, the device is already unlocked, enabling a third party to access the device without needing to unlock it. In one or more embodiments, upon detecting a transition to a sleep state, the operations of the electronic device can further include stopping any active media playback, and locking the electronic device. In this way, disclosed embodiments can serve to prevent unauthorized access by automatically locking an electronic device (such as a smartphone), in response to receiving a sleep status indication from another electronic device (such as a smartwatch) that indicates that a user has transitioned from an awake state to a sleep state. Thus, one or more embodiments can include, in response to detecting an unlocked state of the electronic device, locking the electronic device. Moreover, one or more embodiments can include, in response to detecting an unlocked state of the electronic device concurrently with detecting the sleep status change indicating the device user is asleep, lock the electronic device.

If, at block 508, it is determined that the sleep status has not changed to asleep, then the sleep status change represents the opposite transition, of a user transitioning from being asleep to being awake. Accordingly, the method 500 then proceeds to block 514, where features for unlocking the electronic device based on input from at least one biometric security-access system are enabled. Thus, one or more embodiments can include, in response to the sleep status change indicating the device user transitions from being asleep to being awake, re-enabling the features for unlocking the electronic device based on input from the at least one biometric security-access system of the electronic device.

FIG. 6 depicts a flowchart of a computer-implemented method for generating and issuing alerts and alarms in response to a biometric authentication attempt while the associated user is asleep, according to one or more embodiments. The method 600 starts a block 602, where a user asleep condition is detected, based on receiving a sleep status notification from another electronic device. The method 600 continues to block 604, where a biometric authentication attempt is detected while the user is in the asleep state. The biometric authentication attempt can include a person placing the thumb of a sleeping user on the fingerprint scanner of the user's electronic device, such as depicted in FIG. 2. In response to detecting a biometric authentication attempt while the user is detected/determined to be asleep, the method 600 further continues to block 606, where an alert message is rendered and presented on the electronic device, such as depicted in FIG. 3. The alert can serve to notify the user of an attempt to unlock his/her electronic device via biometric authentication while he/she was asleep. The alert can be stored in the device and presented when next the user authenticates and accesses the device.

The method 600 further continues to block 608, where an audible alarm signal is issued on the electronic device. The audible alarm signal can be output from a speaker integrated into the electronic device (e.g., 144 of FIG. 1). The audible alarm signal can serve to awaken a user when a device unlock attempt via biometric authentication occurs while the user is sleeping. In this way, the user may be alerted to the incident as soon as possible, and may have an opportunity to identify the malicious actor in the act of attempting to perform the unauthorized device unlocking. Thus, one or more embodiments can include, in response to detecting a biometric authentication attempt while the at least one biometric security-access system is disabled, outputting an audible alarm signal from the electronic device. One or more embodiments can include, in response to detecting a biometric authentication attempt while the user is determined to be asleep, outputting an audible alarm signal from the electronic device. The method 600 further continues to block 610, where optionally, a wakeup message is sent to the second electronic device. The wakeup message can include an instruction and/or command to cause the second electronic device to attempt to wake the user. In a scenario where the second electronic device is a wearable electronic device, such as a smartwatch, the wakeup message sent to the wearable electronic device may cause the wearable electronic device to activate a haptic transducer, vibrator, or other haptic device in order to awaken the user. In this way, the user may be woken up while the unauthorized unlock attempt of his/her electronic device is in progress, in order to prevent the unlock attempt and/or to allow the user to identify the malicious actor. Thus, one or more embodiments can include, in response to detecting a biometric authentication attempt while the at least one biometric security-access system is disabled, sending a user wakeup message to the second electronic device. One or more embodiments may execute one or more of the operations shown in FIG. 6 in a different order than shown. One or more embodiments may execute at least two of the operations shown in FIG. 6 concurrently.

As can now be appreciated, disclosed embodiments provide techniques for preventing unauthorized access to an electronic device while a user is asleep, by disabling device unlocking via biometric identification when a user is determined to be asleep. Thus, disclosed embodiments improve the security of electronic devices such as smartphones and tablets by preventing unauthorized unlocking, thereby serving to protect personal privacy, financial information, and other sensitive data.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem enabling the electronic device to communicatively connect to a second electronic device;
a memory having stored thereon a user sleep mode security (USMS) module;
at least one processor coupled to the communications subsystem and the memory and which processes program code of the USMS module, the at least one processor configured to cause the electronic device to:
receive a sleep status indication of a user of the electronic device via the communications subsystem;
detect a sleep status change based on the received sleep status indication; and
in response to the sleep status change indicating the device user is asleep, disable features for unlocking the electronic device based on input from at least one biometric security-access system of the electronic device.

2. The electronic device of claim 1, wherein the at least one processor is further configured to cause the electronic device to:
in response to the sleep status change indicating the device user transitions from being asleep to being awake, re-enable the features for unlocking the electronic device based on input from the at least one biometric security-access system of the electronic device.

3. The electronic device of claim 1, wherein the communications subsystem comprises a Wireless Fidelity (WiFi) module that connects the electronic device to a WiFi network on which the second electronic device is connected and a Bluetooth adapter that provides Bluetooth connectivity with the second electronic device, wherein the electronic device receives the sleep status indication via one of WiFi and Bluetooth.

4. The electronic device of claim 1, wherein the at least one processor is further configured to, in response to detecting an unlocked state of the electronic device concurrently with detecting the sleep status change indicating the device user is asleep, lock the electronic device.

5. The electronic device of claim 1, wherein the at least one biometric security system comprises a fingerprint scanner, and to disable the at least one biometric security system the at least one processor is configured to disable the fingerprint scanner.

6. The electronic device of claim 1, wherein the at least one biometric security-access system comprises a face identification system, and wherein to disable at least one biometric security-access system, the at least one processor is further configured to disable the face identification system.

7. The electronic device of claim 1, wherein the at least one biometric security-access system comprises an iris identification system, and to disable at least one biometric security-access system, the at least one processor is further configured to disable the iris identification system.

8. The electronic device of claim 1, wherein the at least one processor is further configured to, in response to detecting a biometric authentication attempt while the at least one biometric security-access system is disabled, send a user wakeup message to the second electronic device.

9. The electronic device of claim 8, wherein the second electronic device is a wearable electronic device.

10. The electronic device of claim 1, wherein the at least one processor is further configured to, in response to detecting a biometric authentication attempt while the at least one biometric security-access system is disabled, generate and output an audible alarm signal from the electronic device.

11. A method comprising:
receiving, by at least one processor of an electronic device that includes a communications subsystem, a sleep status indication of a user of the electronic device via the communications subsystem;
detecting a sleep status change based on the received sleep status indication; and
in response to the sleep status change indicating the device user is asleep, disabling features for unlocking the electronic device based on input from at least one biometric security-access system of the electronic device.

12. The method of claim 11, further comprising, in response to the sleep status change indicating the device user transitions from being asleep to being awake, re-enabling the features for unlocking the electronic device based on input from the at least one biometric security-access system of the electronic device.

13. The method of claim 11, wherein the sleep status indication is received via a protocol from a group of communication protocols comprising WiFi and Bluetooth.

14. The method of claim 11, further comprising, in response to detecting an unlocked state of the electronic device, locking the electronic device.

15. The method of claim 11, wherein disabling features for unlocking the electronic device based on input from at least one biometric security-access system of the electronic device comprises disabling a fingerprint scanner.

16. The method of claim 11, wherein disabling features for unlocking the electronic device based on input from at least one biometric security-access system of the electronic device comprises disabling a face identification system.

17. The method of claim 11, wherein disabling features for unlocking the electronic device based on input from at least one biometric security-access system of the electronic device comprises disabling an iris identification system.

18. The method of claim 11, further comprising: in response to detecting a biometric authentication attempt while the at least one biometric security-access system is disabled, outputting an audible alarm signal from the electronic device.

19. A computer program product comprising a non-transitory computer readable medium having program instructions that when executed by a processor of an electronic device comprising a communications subsystem that includes at least one wireless interface for communicatively connecting with at least one second electronic device, configure the electronic device to perform functions comprising:
receiving a sleep status indication of a user of the electronic device via the communications subsystem;
detecting a sleep status change based on the received sleep status indication; and
in response to the sleep status change indicating the device user is asleep, disabling features for unlocking the electronic device based on input from at least one biometric security-access system of the electronic device.

20. The computer program product of claim 19, further comprising program instructions for:
in response to detecting a biometric authentication attempt while the at least one biometric security-access system is disabled, outputting an audible alarm signal from the electronic device.
